(19) United States
(12) Patent Application Publication
(10) Pub. No.: US 2004/0172977 A1
(43) Pub. Date: Sep. 9, 2004

(54) Method of producing glass particle-deposited body

(75) Inventors: Motonori Nakamura, Kanagawa (JP); Toshihiro Ooishi, Kanagawa (JP); Tatsuro Sakai, Kanagawa (JP); Yuichi Ohga, Kanagawa (JP)

Correspondence Address: McDERMOTT, WILL & EMERY, 600 13th Street N.W., Washington, DC, 20005-3096, US

(73) Assignee: SUMITOMO ELECTRIC INDUSTRIES, LTD.

(21) Appl. No.: 10/790,223

(22) Filed: Mar. 2, 2004

(30) Foreign Application Priority Data
Mar. 5, 2003 (JP) 2003-058957

(51) Int. Cl. C03B 37/07

(52) U.S. Cl. 65/379

(57) ABSTRACT

A method of producing a glass particle-deposited body having a reduced amount of longitudinal diameter fluctuations with few imperfect points. The method comprises the steps of (a) synthesizing glass particles with at least one burner and (b) moving the at least one burner, a starting material, or both so that the glass particles can adhere onto the surface of the starting material to be deposited there. Two types of vertical spaces in a reaction container are defined; one is the space in which the at least one burner, the starting material's surface onto which the glass particles are to adhere, or both move, and the other is the space enclosed by (a) the position of the at least one burner, (b) the position at which the extended center axis of the at least one burner intersects the opposite wall of the reaction container, and (c) the position of the at least one gas-discharging port. In both spaces, the container's internal pressure at the uppermost position is higher than the container's internal pressure at the lowermost position.

### BACKGROUND OF THE INVENTION

1. Field of the Invention

The present invention relates to a method of producing a porous glass-particle-deposited body that can be used to form, for example, an optical fiber preform by heat consolidation.

2. Description of the Background Art

As a method of producing an optical fiber, a production method is known that comprises the steps of synthesizing an optical fiber preform consisting mainly of SiO₂, elongating the preform, fire polishing, and drawing. The optical fiber preform is synthesized by the following steps.

(a) A porous glass-particle-deposited body is produced by the adhesion and deposition of glass particles onto the surface of a starting materiel.

(b) The porous glass-particle-deposited body is dehydrated and consolidated to obtain a transparent body.

Here, the method of synthesizing the porous glass-particle-deposited body is called a soot process. The types of the soot process include an outside vapor-phase deposition method (OVD method) and a vapor-phase axial deposition method (VAD method).

The soot process, however, has some drawbacks. For example, the diameter of the glass particle-deposited body sometimes fluctuates longitudinally. In addition, the glass particle-deposited body sometimes contain a large number of gas bubbles and portions optically nonuniform with the surrounding portions (they are called imperfect points).

It is known that the above-described diameter fluctuation in the glass particle-deposited body and the generation of the imperfect points can be prevented by forming a smooth air flow in the reaction container for producing the glass particle-deposited body and by stabilizing the flame issuing from the burner for synthesizing glass particles (hereinafter simply referred to as “the burner”). More specifically, the published Japanese patent application Tokukaihei 7-300332 has disclosed a method in which air, particularly clean air, is introduced into the reaction container from the outside through the clearance around the nozzle of the burner. Another published Japanese patent application, Tokukaishou 56-134529, has disclosed a method in which the variation of the pressure in the reaction container is suppressed by detecting the pressure in the reaction container and by introducing a gas for biasing the pressure into the reaction container in accordance with the detected result. Yet another published Japanese patent application, Tokukaishou 61-197439, has disclosed a method in which the gas flow in the reaction container is stabilized by creating a downward-moving gas flow in the gas-flowing space in the reaction container, i.e., the space around the starting material onto which glass particles are to be deposited.

### SUMMARY OF THE INVENTION

An object of the present invention is to offer a method of producing a glass particle-deposited body that has a reduced amount of longitudinal diameter fluctuations with few imperfect points.

According to the present invention, the foregoing object is attained by offering the following method of producing a glass particle-deposited body. The method uses a reaction container provided with:

(a) at least one burner for synthesizing glass particles;

(b) at least one gas-discharging port; and

(c) an exhaust pipe connected to the or each gas-discharging port.

The method comprises the following steps:

(d) Glass particles are synthesized by using the at least one burner in the container.

(e) The at least one burner, a starting material, or both are moved so that the glass particles can adhere onto the surface of the starting material to be deposited there.

The method is specified by the following conditions:

(f) The internal pressure P_{H} of the reaction container is defined as the pressure at the uppermost position in a space for the movement of the at least one burner, the starting material's surface onto which the glass particles are to adhere, or both.

(g) The internal pressure P_{L} of the reaction container is defined as the pressure at the lowermost position in the foregoing space.

(h) The pressure P_{H} is adjusted to be higher than the pressure P_{L} by 2 to 30 Pa.

According to one aspect of the present invention, the present invention offers the following method of producing a glass particle-deposited body. The method uses a reaction container provided with:

(a) at least one burner for synthesizing glass particles;

(b) at least one gas-discharging port; and

(c) an exhaust pipe connected to the or each gas-discharging port.

The method comprises the following steps:

(d) Glass particles are synthesized by using the at least one burner in the container.

(e) A starting material is vertically raised so that the glass particles can adhere onto the surface of the starting material to be deposited there.

The method is specified by the following conditions:

(f) The highest and lowest positions are determined from the following group of positions:

(f1) the position of the top of the at least one burner;

(f2) the position at which the center axis of the at least one burner extended in the direction of the flame issuing from the at least one burner intersects the wall of the reaction container; and

(f3) the position at which the at least one gas-discharging port is placed.

(g) The reaction container's pressure P_{H}′ at the highest position is adjusted to be higher than the reaction container's pressure P_{L}′ at the lowest position by 2 to 30 Pa.

According to another aspect of the present invention, the present invention offers the following method of producing a glass particle-deposited body. The method uses a reaction container provided with:

(a) at least one burner for synthesizing glass particles;

(b) at least two gas-discharging ports; and

(c) an exhaust pipe connected to each of the at least two gas-discharging ports.

The method comprises the following steps:

(d) Glass particles are synthesized by using the at least one burner in the container.

(e) The glass particles are caused to adhere onto the surface of a starting material to be deposited there.

The method is specified by the condition that the pressure in the exhaust pipe is adjusted such that the pressure increases with increasing height of the position of the gas-discharging port to which the exhaust pipe is connected.

Advantages of the present invention will become apparent from the following detailed description, which illustrates the best mode contemplated to carry out the invention. The invention can also be carried out by different embodiments, and their details can be modified in various respects, all without departing from the invention. Accordingly, the accompanying drawing and the following description are illustrative in nature, not restrictive.

### BRIEF DESCRIPTION OF THE DRAWING

The present invention is illustrated to show examples, not to show limitations, in the figures of the accompanying drawing. In the drawing, the same reference signs and numerals refer to similar elements.

In the drawing:

FIGS. 1A and 1B are schematic diagrams showing an embodiment of the method of producing a porous glass-particle-deposited body of the present invention in the multiple-burner multilayer deposition method, a type of the OVD method, in which FIG. 1A shows a state when the starting material is positioned at the uppermost position and FIG. 1B shows a state when it is positioned at the lowermost position.

FIG. 1C is a diagram showing an example of the reciprocating pattern of the starting material in the embodiment shown in FIGS. 1A and 1B.

FIGS. 2A and 2B are schematic diagrams showing an embodiment of the method of producing a porous glass-particle-deposited body of the present invention in another embodiment of the OVD method, in which FIG. 2A shows a state when burners 5 are positioned at the uppermost position and FIG. 2B shows a state when they are positioned at the lowermost position.

FIG. 3 is a schematic diagram showing an embodiment of the method of producing a porous glass-particle-deposited body of the present invention in the VAD method.

FIG. 4A is a schematic diagram showing an embodiment of the gas-discharging ports and exhaust pipes employed for the reaction container 3 shown in FIGS. 1A, 2A, and 3.

FIG. 4B is a schematic diagram showing the positions for measuring the pressures in the exhaust pipes and reaction container of a reaction apparatus to be used in the production method of the present invention.

FIG. 4C is a schematic diagram showing an example of the positions for measuring the pressures in the exhaust pipes and reaction container shown in FIG. 4B.

### DETAILED DESCRIPTION OF THE INVENTION

In this specification, the term “starting material” is used to mean a material onto the surface of which glass particles synthesized with a burner adhere and are deposited. A glass rod is usually used as the starting material. The glass rod can be made of the glass containing dopants, the glass containing no dopants, or both depending on the application. According to the production method of the present invention, after a deposited layer of glass particles is formed on the starting material, glass particles are further deposited.

In this specification, the term “burner for synthesizing glass particles” is used to mean a burner that has the following features. The burner usually has a plurality of circular gas-ejecting ports placed concentrically. The ports eject (a) a material gas containing a gas such as, silicon tetrachloride (SiCl₄) or a mixed gas of SiCl₄ and germanium tetrachloride, (b) a combustion gas composed of hydrogen (H₂) and oxygen (O₂), and (c) an inert gas such as argon (Ar). These ejected gases are mixed to burn the H₂ so that the material gas can be flame-hydrolyzed. As a result, glass particles are produced. The burner is well known to the persons skilled in the art. In the present invention, it is desirable that the material gas be composed of the above-described gas.

In this specification, the term “porous glass-particle-deposited body” is used to mean a porous glass body produced by the adhesion and deposition of the glass particles formed with the “burner for synthesizing glass particles” onto the surface of the starting material. The porous glass-particle-deposited body can be further processed by dehydration and consolidation to produce a transparent glass preform to be used as the material for producing an optical fiber.

In this specification, when the term “pressure” is used to refer the pressure in a reaction container, an exhaust pipe, and so on, the term “pressure” indicates the pressure of the atmospheric gas at the measuring position.

In this specification, the term “center of the gas-discharging port” has the following meanings, for example:

(a) When the port has the shape of a circle, the term means the center of the circle.

(b) When the port has the shape of an ellipse, the term means the intersection between the major and minor axes.

(c) When the port has the shape of a square, the term means the intersection between the diagonal lines.

However, the above definition is not strict. The term is used to mean the position in the vicinity of the center of the gas-discharging port as dictated by common knowledge.

In this specification, the term “pressure in an exhaust pipe” is used to mean the pressure measured at a position in the vicinity of the connecting portion between the reaction container and the exhaust pipe, the measuring position being about 10 cm apart from the gas-discharging port. The term “pressure in a reaction container” is used to mean the pressure measured at a position in the vicinity of the wall of the reaction container.

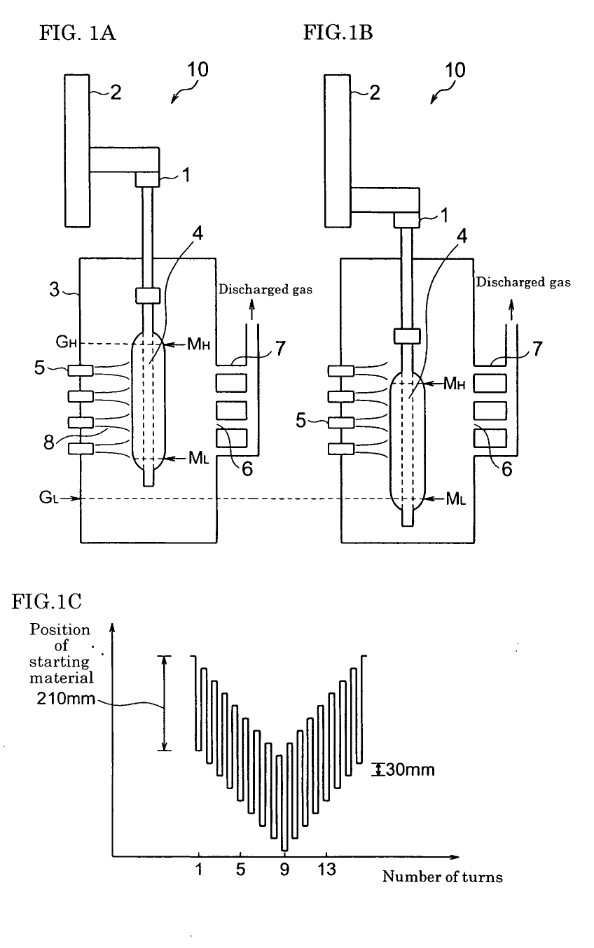

The production method of the present invention is explained below by referring to the drawing. FIGS. 1A and 1B are schematic diagrams showing an embodiment of the method of producing a porous glass-particle-deposited body of the present invention in the multiple-burner multilayer deposition method, a type of the OVD method. FIG. 1A shows a state when the starting material is positioned at the uppermost position, and FIG. 1B shows a state when it is positioned at the lowermost position. In FIGS. 1A and 1B, a starting material 4 is coupled with a rotating device 1 at its top such that its rotation axis is positioned vertically. The rotating device 1 is coupled with a raising-and-lowering mechanism 2, which can move up and down. The starting material 4 is enclosed by a reaction container 3. The reaction container 3 is provided with burners 5 for synthesizing glass particles on its wall such that flames 8 issuing from the burners face the starting material 4. The reaction container 3 is provided with gas-discharging ports 6 on its wall opposite to the wall provided with the burners 5 with respect to the starting material 4. Each of the gas-discharging ports 6 is connected to an exhaust pipe 7. FIGS. 1A and 1B show an example in which four burners, four gas-discharging ports, and four exhaust pipes are provided. However, the number of these members is not limited to four. Any number may be used.

FIG. 1C shows an example of the reciprocating pattern of the starting material in the embodiment shown in FIGS. 1A and 1B. As can be seen from FIG. 1C, the starting material first descends by 210 mm, then turns upward to ascend by 180 mm, and turns downward. Thus, the starting material performs 10 reciprocating motions by shifting the turning position downward by 30 mm at each turn. Next, it performs 10 reciprocating motions by shifting the turning position upward by 30 mm at each turn to return to the starting position. In the multiple-burner multilayer deposition method, it is desirable that the starting material perform reciprocating motions as shown in FIG. 1C.

The starting material 4 is rotated by the rotating device 1 and repeatedly moved up and down by the raising-and-lowering mechanism 2. The surface of the reciprocating starting material 4 is blown by the flames 8 issuing from the burners 5. Glass particles contained in the flames adhere onto the surface of the starting material 4 and are deposited there. Gases to be discharged in the flames 8, the remaining glass particles without adhering onto the surface of the starting material 4, and other substances are discharged to the outside of the reaction container via the gas-discharging ports 6 and the exhaust pipes 7.

The range of and method for adjusting the pressure in the reaction container are explained below. In FIG. 1A, the adhesion and deposition of glass particles (hereinafter simply referred to as “sooting”) take place on the lower portion of the starting material 4. The sign “M_{L}” denotes the lowermost position of the surface of the starting material to be sooted. In FIG. 1B, on the other hand, the “sooting” is performed on the upper portion of the starting material 4. The sign “M_{H}” denotes the uppermost position of the surface of the starting material to be sooted. In the reaction container 3, the moving range of the starting material 4's surface to be sooted is shown by the space whose upper end is denoted as “G_{H}” in FIG. 1A and whose lower end is denoted as “G_{L}” in FIG. 1B. According to the present invention, the container's internal pressure P_{H} at the height of the position G_{H} in the space of the reaction container is adjusted to be higher than the container's internal pressure P_{L} at the height of the position G_{L}. When the pressure depends on the horizontal position even at the same height, the lowest pressure at the height of the position G_{H} is employed as the container's internal pressure P_{H} and the highest pressure at the height of the position G_{L} is employed as the container's internal pressure P_{L}.

The amount of the increment of the pressure P_{H} over the pressure P_{L} must satisfy the following requirements:

(a) The gas flow in the reaction container is maintained smooth.

(b) The flow of the flames issuing from the burners is not disturbed.

(c) The diameter fluctuation in the glass particle-deposited body is suppressed to be small.

(d) The number of imperfect points in the glass particle-deposited body is reduced.

More specifically, it is desirable that the amount of the increment of the pressure P_{H} over the pressure P_{L} be 2 to 30 Pa, more desirably 5 to 30 Pa, preferably 10 to 25 Pa.

Any method may be employed to attain the pressure P_{H} higher than the pressure P_{L} on condition that the method achieve the object of the present invention. Among these methods, a first method is as follows:

(a) Each of the gas-discharging ports, the exhaust pipes, or both is provided with a device for adjusting the amount of gas to be discharged from the reaction container per unit time.

(b) The pressure in the exhaust pipe is adjusted such that the pressure increases with increasing height of the reaction container's position to which the exhaust pipe is connected.

When the reaction container is provided with three or more gas-discharging ports and exhaust pipes, it is desirable to adjust the pressure in the exhaust pipe such that the pressure increases with increasing height of the reaction container's position to which the exhaust pipe is connected in order to stabilize the flow of the flames issuing from the burners and to attain a smooth flow of the gas in the reaction container. In some cases, however, the pressure P_{H} higher than the pressure P_{L} can be attained without performing the above-described adjustment.

The amount of the reaction container's gas to be discharged per unit time through individual exhaust pipes can be adjusted by employing any of the following methods:

(1) to provide each individual exhaust pipe with an adjusting device that introduces an adjusted amount of air from the outside into the exhaust pipe at a position downstream from the gas-discharging port;

(2) to vary the inner diameter of the individual exhaust pipes (more specifically, an exhaust pipe at a higher position of the reaction container has a smaller inner diameter than that of an exhaust pipe at a lower position); and

(3) to provide each individual exhaust pipe with a damper to adjust the volume of air through the damper.

Notwithstanding the above description, the adjusting method is not limited to the above examples.

A second method to attain the pressure P_{H} higher than the pressure P_{L} is as follows:

(a) The reaction container is provided with a heat source.

(b) The heat source supplies heat into the reaction container to generate an upward-moving gas flow.

(c) The upward-moving gas flow increases the container's internal pressure as the position rises.

The concrete examples of the method include (a) heating with a heater of a resistance furnace, (b) an introduction of pre-heated air into the reaction container, and (c) heating with an infrared heater. These methods may be used singly or in combination of at least two methods.

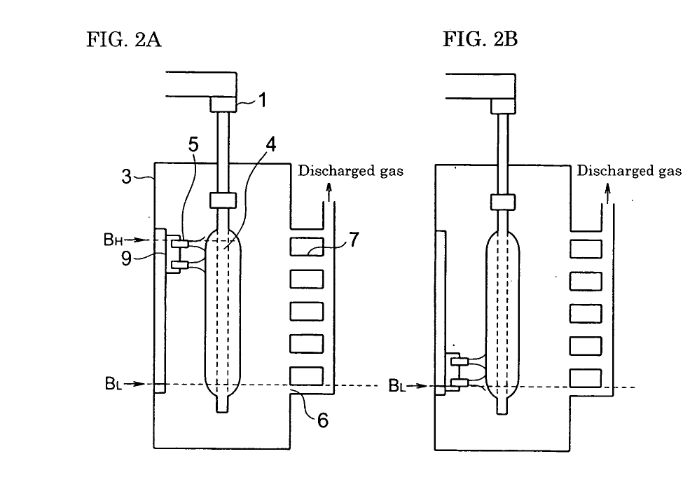

FIGS. 2A and 2B are schematic diagrams showing an embodiment of the method of producing a glass particle-deposited body of the present invention in another embodiment of the OVD method. FIG. 2A shows a state when burners 5 are positioned at the uppermost position, and FIG. 2B shows a state when they are positioned at the lowermost position. In FIGS. 2A and 2B, a starting material 4 is coupled with a rotating device 1 at its top such that its rotation axis is positioned vertically. The starting material 4 is enclosed by a reaction container 3. The reaction container 3 is provided in it with burners 5, which are coupled with a burner-moving mechanism 9 capable of moving up and down. The burners 5 are placed such that flames issuing from the burners 5 face the starting material 4. The reaction container 3 is provided with gas-discharging ports 6 on its wall opposite to the wall provided with the burners 5 with respect to the starting material 4. Each of the gas-discharging ports 6 is connected to an exhaust pipe 7. FIGS. 2A and 2B show an example in which two burners, six gas-discharging ports, and six exhaust pipes are provided. However, the number of these members is not limited to two or six. Any number may be used.

In FIGS. 2A and 2B, the starting material 4 is rotated by the rotating device 1 and the burners 5 are repeatedly moved up and down by the burner-moving mechanism 9. The surface of the starting material 4 is blown by the flames issuing from the reciprocating burners 5. Glass particles contained in the flames adhere onto the surface of the starting material 4 and are deposited there. Gases to be discharged in the flames, the remaining glass particles without adhering onto the surface of the starting material 4, and other substances are discharged to the outside of the reaction container via the gas-discharging ports 6 and the exhaust pipes 7.

In the method shown in FIGS. 2A and 2B, the range of and method for adjusting the pressure in the reaction container are explained below. In FIG. 2A, the sign “B_{H}” denotes the uppermost position of the moving range of the burners 5 and the sign “B_{L}” denotes the lowermost position. In the reaction container 3, the moving range of the burners is shown by the space whose upper end is denoted as “B_{H}” in FIG. 2A and whose lower end is denoted as “B_{L}.” According to the present invention, the container's internal pressure P_{H} at the height of the position B_{H} in the space of the reaction container is adjusted to be higher than the container's internal pressure P_{L} at the height of the position B_{L}. By the same reason as explained in the embodiment shown in FIGS. 1A and 1B, it is desirable that the amount of the increment of the pressure P_{H} over the pressure P_{L} be 2 to 30 Pa, more desirably 5 to 30 Pa, preferably 10 to 25 Pa.

When the container's internal pressure depends on the horizontal position even at the same height, the definition of the container's internal pressures is the same as in the embodiment shown in FIGS. 1A and 1B. In addition, the method to attain the pressure P_{H} higher than the pressure P_{L} may be the same method as explained in the embodiment shown in FIGS. 1A and 1B and the desirable embodiment of the method is also the same.

In the embodiment shown in FIG. 1A, it is desirable that the gas-discharging ports be placed at the same height as that of the burners for synthesizing glass particles.

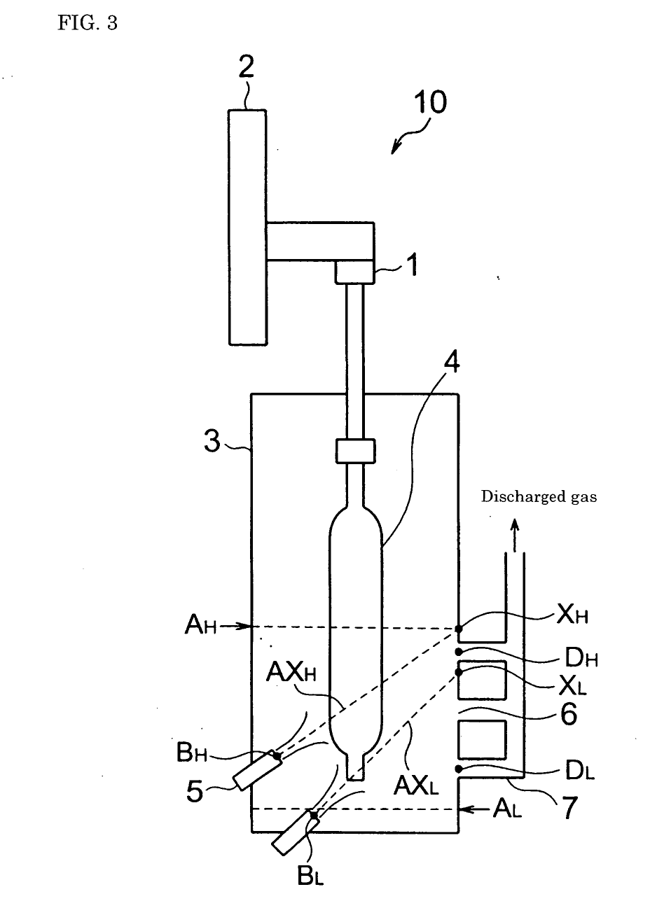

FIG. 3 is a schematic diagram showing an embodiment of the method of producing a porous glass-particle-deposited body of the present invention in the VAD method. In FIG. 3, a starting material 4 is coupled with a rotating device 1 at its top such that its rotation axis is positioned vertically. The rotating device 1 is coupled with a raising-and-lowering mechanism 2, which can at least move up. The starting material 4 is enclosed by a reaction container 3. The reaction container 3 is provided in it with burners 5. The burners 5 are placed such that flames issuing from the burners 5 face the lower portion of the starting material 4. The reaction container 3 is provided with gas-discharging ports 6 on its wall opposite to the wall provided with the burners 5 with respect to the starting material 4. Each of the gas-discharging ports 6 is connected to an exhaust pipe 7. FIG. 3 shows an example in which two burners, three gas-discharging ports, and three exhaust pipes are provided. However, any number may be used as the number of these members.

In FIG. 3, the starting material 4 is rotated by the rotating device 1 and raised vertically by the raising-and-lowering mechanism 2. The surface portion in the vicinity of the lower end of the rising starting material 4 is blown by the flames issuing from the burners 5. Glass particles contained in the flames adhere onto the surface of the starting material 4 and are deposited there. Gases to be discharged in the flames, the remaining glass particles without adhering onto the surface of the starting material 4, and other substances are discharged to the outside of the reaction container via the gas-discharging ports 6 and the exhaust pipes 7. This method is known as the so-called VAD method.

In the method shown in FIG. 3, the range of and method for adjusting the pressure in the reaction container are explained below. In the apparatus shown in FIG. 3, the signs “B_{H}” and “B_{L}” show the positions of the top of the two burners, respectively. The signs “X_{H}” and “X_{L}” show the positions at which the center axes of the burners AX_{H} and AX_{L} extended in the direction of the flames issuing from the burners intersect the wall of the reaction container 3, respectively. The sign “D_{H}” shows the highest position among the three gas-discharging ports 6, and the sign “D_{L}” shows the lowest position. In FIG. 3, the position X_{H} is the highest among the above-described positions and the position B_{L} is the lowest. Consequently, in the present invention, the internal pressure P_{H} of the reaction container' at the height of the position A_{H} (whose height is the same as that of the position X_{H}) is adjusted to be higher than the internal pressure P_{L} of the reaction container' at the height of the position A_{L} (whose height is the same as that of the position B_{L}). By the same reason as explained in the embodiment shown in FIGS. 1A and 1B, it is desirable that the amount of the increment of the pressure P_{H}′ over the pressure P_{L}′ be 2 to 30 Pa, more desirably 5 to 30 Pa, preferably 10 to 25 Pa. In the above description, the position of the gas-discharging port 6 means the center position of the port.

When the container's internal pressure depends on the horizontal position even at the same height, the definition of the container's internal pressures is the same as in the embodiment shown in FIGS. 1A and 1B. In addition, the method to attain the pressure P_{H}′ higher than the pressure P_{L}′ may be the same as the method to attain the pressure P_{H} higher than the pressure P_{L}, which is explained in the embodiment shown in FIGS. 1A and 1B. The desirable embodiment of the method is also the same.

In another embodiment of the production method of the present invention, when the apparatus for producing a glass particle-deposited body is provided with at least two gas-discharging ports and an exhaust pipe connected to each of the at least two gas-discharging ports, the pressure in the exhaust pipe is adjusted such that the pressure increases with increasing height of the position of the exhaust pipe.

In the above-explained embodiments of the production method of the present invention, pressures at the following positions are measured.

(a) The reaction container's internal pressure is measured at a position some distance apart from the center of each of the multiple gas-discharging ports.

(b) The internal pressure of each of the exhaust pipes connected to the gas-discharging ports is measured at a position some distance apart from the center of the gas-discharging port to which it is connected.

The difference between the two pressures expressed in (a) and (b) above with respect to each of the gas-discharging ports is obtained (hereinafter the difference is referred to as the difference between the inside and outside pressures of the gas-discharging port). It is desirable that the difference between the inside and outside pressures of each of the gas-discharging ports be adjusted to fall within the range of 70% to 130% of the average value of the differences between the inside and outside pressures of all of the gas-discharging ports, more desirably within the range of 80% to 120%, preferably within the range of 90% to 110%. The above-described adjustment of the difference between the inside and outside pressures of each of the gas-discharging ports can stabilize not only the flow of the gas in the reaction container but also the flow of the flames issuing from the burners. This stabilization enables the production of a glass particle-deposited body that has a reduced amount of longitudinal diameter fluctuations with few imperfect points.

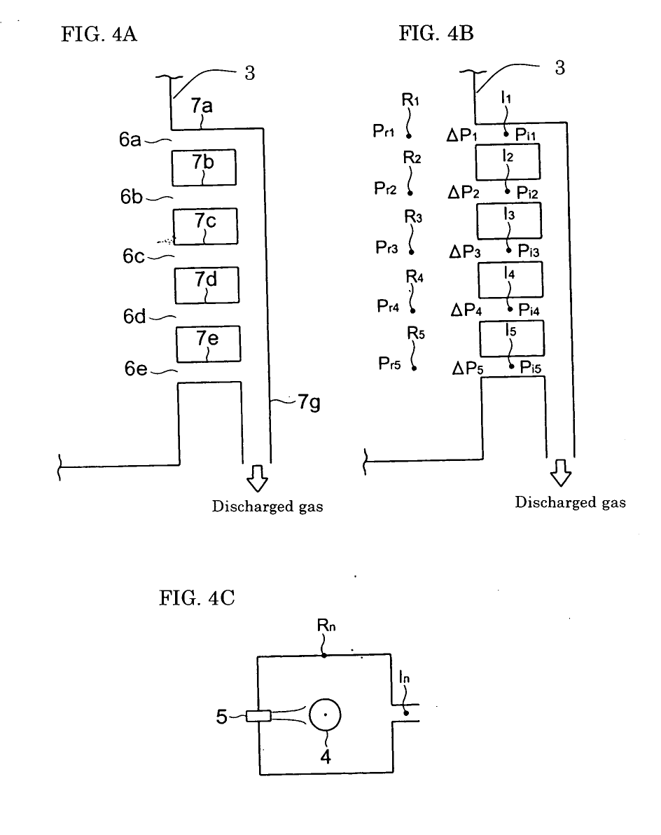

In the above description, the position for measuring the pressure in the reaction container and the position for measuring the pressure in the exhaust pipes can be determined according to the structure of the apparatus without much limitation. However, if the two positions are excessively close to each other, the difference in pressure between the two positions is so small that the measurement error is increased. In the production method of the present invention, it is desirable that the pressure in the exhaust pipe be measured at a position about 10 cm apart from the gas-discharging port. It is desirable that the reaction container's internal pressure be measured at a position that is located at the same height as that of the gas-discharging port, that is apart from both of the burner and the gas-discharging port as far as possible, and that is in the vicinity of the wall of the reaction container. For example, when the burner and the gas-discharging port are placed at opposite positions with respect to the starting material in a reaction container, it is desirable that the reaction container's internal pressure be measured at the below-described position. A first line is drawn through the burner and the gas-discharging port. A second line perpendicular to the first line is drawn through the starting material. One of the intersections between the second line and the wall of the reaction container is used as the measuring position. (See FIG. 4C, where “Rₙ” shows the measuring position.)

In particular, it is desirable that the adjustment of the difference between the inside and outside pressures of the gas-discharging port be performed together with the above-described pressure adjustment in which the pressure in the exhaust pipe is adjusted such that the pressure increases with increasing height of the position of the exhaust pipe. Notwithstanding the above description, in some cases, both the flow of the gas in the reaction container and the flow of the flames issuing from the burners can be stabilized without performing the above-described concurrent pressure adjustments.

The above-described pressure adjustments with regard to the gas-discharging ports and the inside of the exhaust pipes are explained more specifically below by referring to FIGS. 4A to 4C. FIG. 4A is a schematic diagram showing an embodiment of the gas-discharging ports and exhaust pipes employed for the reaction container 3 shown in FIGS. 1A, 2A, and 3.

In FIG. 4A, the reaction container 3 is provided with five gas-discharging ports 6a to 6e, to which exhaust pipes 7a to 7e are connected, respectively. The exhaust pipes 7a to 7e are connected to a common exhaust pipe 7g. In FIG. 4A, the upside of the drawing corresponds to the upside of the reaction container. FIG. 4B shows the positions for measuring the reaction container's internal pressure in the vicinity of the gas-discharging ports shown in FIG. 4A and the positions for measuring the pressures in the exhaust pipes shown in FIG. 4A. FIG. 4C shows the relative positions of the measuring points with regard to the gas-discharging ports 6a to 6e. Measuring points R₁ to R₅ are each located on the wall of the reaction container at the same height as that of the center of the corresponding gas-discharging ports. The signs “Pᵣ₁” to “Pᵣ₅” show the atmospheric pressure in the container at the measuring points. The signs “I₁” to “I₅” show the positions in the exhaust pipes 10 cm apart from the center of the gas-discharging ports. The signs “Pᵢ₁” to “Pᵢ₅” show the atmospheric pressure in the pipes at the measuring points. The differences between the inside and outside pressures of the gas-discharging ports are denoted by ΔP₁ to ΔP₅. They are calculated by using the equation ΔPₙ=Pᵣₙ−Pᵢₙ. In the case of the apparatus shown in FIGS. 4A to 4C, the average value of the differences between the inside and outside pressures of the gas-discharging ports (ΔPₐᵥ) is calculated by using the equation ΔPₐᵥ=(ΔP₁+ΔP₂+ΔP₃+ΔP₄+ΔP₅)/5.

In the production method of the present invention, as described above, it is desirable that the pressure in the exhaust pipe be adjusted such that the pressure increases with increasing height of the position of the exhaust pipe. In other words, in FIG. 4B, it is desirable that the adjustment be performed to achieve the relationship Pᵢ₁>Pᵢ₂>Pᵢ₃>Pᵢ₄>Pᵢ₅.

In addition, it is desirable that the differences between the inside and outside pressures of the gas-discharging ports ΔP₁ to ΔP₅ be adjusted to fall within ΔPₐᵥ±ΔPₐᵥ×0.3, more desirably ΔPₐᵥ±ΔPₐᵥ×0.2, preferably ΔPₐᵥ±ΔPₐᵥ×0.1.

As described above, the methods for adjusting the pressure in the exhaust pipe, the difference between the inside and outside pressures of the gas-discharging port, or both can be achieved by, for example, installing a device for adjusting the amount of gas to be discharged from the reaction container per unit time at each gas-discharging port, each exhaust pipe, or both. More specifically, any of the following methods can be employed:

(1) to provide each individual exhaust pipe with an adjusting device that introduces an adjusted amount of air from the outside into the exhaust pipe at a position downstream from the gas-discharging port;

(2) to vary the inner diameter of the individual exhaust pipes (more specifically, an exhaust pipe at a higher position of the reaction container has a smaller inner diameter than that of an exhaust pipe at a lower position); and

(3) to provide each individual exhaust pipe with a damper to adjust the volume of air through the damper.

Notwithstanding the above description, the adjusting method is not limited to the above examples. As shown in FIGS. 4A and 4B, when the gas discharging is performed by connecting the exhaust pipes 7a to 7e to the common exhaust pipe 7g, it is desirable to place the exhaust pipe 7g so that the gas discharging can be performed downward, because this arrangement facilitates increasing the pressure in the exhaust pipes 7a to 7e as the position becomes higher.

In the method of producing a glass particle-deposited body of the present invention, when a clean gas is fed into the reaction container by providing the container with a clean gas-feeding port, both the flow of the gas in the reaction container and the flow of the flames issuing from the burners can be further stabilized. Here, the “clean gas” is defined as a gas that contains a minimum amount of solid and liquid particles. The gas is usually produced by the filtration as the person skilled in the art knows. It is desirable that the clean gas to be used in the present invention be a class 100 or below gas, for example. The types of clean gas to be used in the present invention include gases such as air, nitrogen, Ar, helium and a mixed gas of at least two types of gases selected from them. However, the type of gas is not limited to the above examples. In particular, it is desirable to use air as the clean gas.

To feed the clean gas into the reaction container, the container is provided with a clean gas-feeding port. It is desirable to place the clean gas-feeding port at a place that does not disturb the flow of the flame issuing from the burner. To satisfy this requirement, it is undesirable that the clean gas be ejected in a direction opposite to that of the flow of the flame issuing from the burner. It is desirable that the clean gas flow nearly in the same direction as that of the flow of the flame so that the flame cannot be disturbed. Therefore, it is desirable to place the clean gas-feeding port at the same height as that of the burner placed in the reaction container. In other words, it is desirable to place it at the side of the burner. If the clean gas-feeding port has a vertical dimension larger than the diameter of the burner, it is desirable to place the clean gas-feeding port such that the range of the vertical dimension include the range of the height corresponding to the diameter of the burner. In the case of a reaction container provided with a plurality of burners, it is desirable to provide a clean gas-feeding port at both sides of each burner. However, this arrangement is based on the assumption that the clean gas would generally be fed nearly horizontally into the reaction container. If the flow of the clean gas does not disturb the flow of the flame issuing from the burner, the position of the clean gas-feeding port is not limited to the above-described position. For example, the clean gas-feeding port may be placed at a height different from that of the position of the burner. In addition, it is desirable that the pressure of the clean gas just before issuing from the clean gas-feeding port be the same as or higher than the pressure in the reaction container at the same height. Here, “the pressure in the reaction container at the same height as that of the feeding port” is defined as the maximum pressure in a plane with the same height in the reaction container. The above-described arrangement reduces the disturbance in the flow of gas in the plane. The feeding amount of the clean gas may be adjusted freely providing that the amount can exercise the effect of the present invention. Generally, however, it is desirable that the amount per unit time be the same as or less than that of the gas issuing from the burner into the reaction container. If an excessive amount of clean gas is fed, the gas flow in the reaction container is disturbed.

### EXAMPLE 1, COMPARATIVE EXAMPLE 1

An apparatus having the structure shown in FIG. 1A was used. Four burners were placed with intervals of 210 mm. The burners were fixed, and the starting material was moved as shown in FIG. 1C. More specifically, the turning position of the starting material was shifted by 30 mm at each turn. The direction of the shifting of the turning position was reversed after the starting material moved a specified distance. Glass particles were deposited onto the surface of the starting material until the maximum diameter of the glass particle-deposited body reached 200 mm. Each burner was supplied with a material gas of SiCl₄ at 4 SLM, H₂ at 100 SLM, 02 at 100 SLM, and Ar at 10 SLM. Here, the term “SLM” is the abbreviation of the “standard liter per minute.”

The angle of the damper installed in each exhaust pipe was adjusted to discharge the gas more forcefully from an exhaust pipe at a lower position than from an exhaust pipe at a higher position. This adjustment generated a pressure difference between the uppermost and lowermost positions in the moving range of the starting material's surface onto which glass particles adhered. Thus, glass particle-deposited bodies were produced. Table I shows the effect of the difference between the pressure at the uppermost position P_{H} and the pressure at the lowermost position P_{L}, i.e., P_{H}-P_{L}, on the longitudinal diameter fluctuation (difference between the maximum and minimum diameters) of the obtained glass particle-deposited body and the average yield (%) of the glass particle-deposited body.

TABLE I

| Uppermost-position pressure − | | |
|---|---|---|
| lowermost-position pressure | Diameter fluctuation | Average yield |
| (Pa) | (mm) | (%) |
| 1 | 15 | 65 |
| 2 | 5 | 70 |
| 5 | 4 | 75 |
| 10 | 3 | 75 |
| 15 | 3 | 75 |
| 20 | 2 | 75 |
| 25 | 2 | 70 |
| 30 | 2 | 68 |
| 35 | 2 | 50 |

As can be seen from Table I, when the pressure difference between the uppermost and lowermost positions was less than 2 Pa, the obtained glass particle-deposited body showed a longitudinal diameter fluctuation as high as at most 15 mm. When the pressure difference exceeded 30 Pa, the average yield decreased, apparently because the gas flow in the reaction container was disturbed. Here, the average yield is the ratio of the amount of the deposited glass on the starting material to the amount of the glass used as the material gas, expressed in mol. %. As described above, because the gas flow in the reaction container and the flow of the flame issuing from the burner were stabilized, the glass particles synthesized by the burner adhered onto the surface of the starting material and were deposited there with a higher efficiency than conventional methods.

### EXAMPLE 2, COMPARATIVE EXAMPLE 2

An apparatus having the structure shown in FIG. 2A was used. Two burners were combined with a mutual distance of 150 mm. In the apparatus shown in FIG. 2A, each exhaust pipe 7 was provided with a device that could directly introduce air into the exhaust pipe so that the adjustment of the amount of air introduced into each exhaust pipe could control the pressure in the exhaust pipe. While the combination of the burners was reciprocating in a specified range, glass particles were deposited onto the surface of the starting material until the maximum diameter of the glass particle-deposited body reached 150 mm. The amount of air introduced into each exhaust pipe was adjusted to vary the pressure in the exhaust pipe. Thus, glass particle-deposited bodies were produced. Table II shows the effect of the pressure difference (Pa) between the uppermost and lowermost positions during the production on the diameter fluctuation (mm) and average yield (%) of the obtained glass particle-deposited body.

TABLE II

| Uppermost-position pressure − | | |
|---|---|---|
| lowermost-position pressure | Diameter fluctuation | Average yield |
| (Pa) | (mm) | (%) |
| 1 | 20 | 60 |
| 2 | 6 | 71 |
| 5 | 5 | 74 |
| 10 | 4 | 75 |
| 15 | 4 | 76 |
| 20 | 3 | 73 |
| 25 | 2 | 71 |
| 30 | 2 | 67 |
| 35 | 2 | 53 |

As can be seen from Table II, when the pressure difference between the uppermost and lowermost positions was less than 2 Pa, the diameter fluctuation was high. When the pressure difference exceeded 30 Pa, the average yield decreased.

### EXAMPLE 3, COMPARATIVE EXAMPLE 3

Glass particle-deposited bodies having a diameter of 150 mm were produced by using an apparatus incorporating the VAD method having the structure shown in FIG. 3. The core region was synthesized by feeding GeCl₄ and SiCl₄ as a material gas into the burner placed at the central side of the starting material. The cladding region was synthesized by feeding only SiCl₄ as a material gas into the burner placed at the peripheral side of the starting material. The sooting was carried out while the adjustment of the pressure at the uppermost position (A_{H}) and the pressure at the lowermost position (A_{L}) was performed. When the pressure difference between the uppermost and lowermost positions exceeded 30 Pa, cracks developed at the side of the cladding region during the sooting operation. When the pressure difference was 1 Pa, the result was unsatisfactory because of the high fluctuation in the diameter of the cladding region, i.e., the diameter of the glass particle-deposited body. On the other hand, when the pressure difference was in the range of 2 to 30 Pa, cracks did not develop and the diameter fluctuation was small. In other words, a glass particle-deposited body was produced with high quality.

### EXAMPLE 4

An apparatus and a production method both similar to those used in Example 1 were used. Pressures at various positions shown in FIGS. 4A to 4C were measured for the production of the glass particle-deposited body. The pressures were controlled to satisfy the condition P_{X1}>P_{X2}>P_{X3}>P_{X4}>P_{X5}, where “X” represents “r” for the pressure in the reaction container and “i” for the pressure in the exhaust pipe. Under this condition, the pressure difference ΔP was varied to observe the effect of the variation of ΔP on the longitudinal diameter fluctuation of the obtained glass particle-deposited body. The diameter fluctuation shows the stability of the shape of the glass particle-deposited body. The sooting was performed until the diameter of the glass particle-deposited body reached 180 mm.

Based on the obtained data of the pressure, the degree of variation in the pressure difference was calculated by using the below-stated equation to observe the relationship with the magnitude of the diameter fluctuation of the glass particle-deposited body. The pressure in the exhaust pipe was measured at a position 10 cm apart from the gas-discharging port. The pressure in the reaction container was measured at a position where the height was the same as that of the position for measuring the pressure in the exhaust pipe and where a line drawn through the center of the starting material in a direction perpendicular to another line drawn through the gas-discharging port and the center of the starting material intersected the wall of the reaction container. The degree of variation in the pressure difference was calculated by using the following equation:

Degree of variation in ΔP (%)={maximum deviation of ΔP}÷ΔPₐᵥ×100,

where {maximum deviation of ΔP}=maximum value among |ΔPₙ−ΔPₐᵥ|

where ΔPₙ represents ΔP₁, ΔP₂, ΔP₃, ΔP_{X4}, and ΔP₅, and

ΔPₐᵥ is the average value of ΔPₙ.

The obtained results are shown in Table III.

TABLE III

| | Maximum deviation | Degree of variation | |
|---|---|---|---|
| ΔPₐᵥ | of ΔP | in ΔP | Diameter fluctuation |
| (Pa) | (Pa) | (%) | (mm) |
| 15 | 5 | 33 | 10 |
| 15 | 2 | 13 | 3 |
| 20 | 5 | 25 | 8 |
| 20 | 2 | 10 | 2 |
| 25 | 5 | 20 | 4 |
| 25 | 2 | 8 | 2 |

When the pressure at the highest position is adjusted to be higher than the pressure at the lowest position, the magnitude of the diameter fluctuation of the obtained glass particle-deposited body can be reduced. In addition, when the variation of each value of ΔP against the average value of ΔP is decreased, the diameter fluctuation is reduced.

### EXAMPLE 5, COMPARATIVE EXAMPLE 4

Glass particle-deposited bodies were produced by a method similar to that used in Example 1, except that a vertically oriented opening having a height of 100 mm and a width of 30 mm was placed at both sides of each burner. Clean air was introduced from the outside into the reaction container through the opening. The total amount of the clean air introduced through all of the openings was 800 liter per minute.

As can be seen from Table IV, the results showed that the diameter fluctuation of the obtained glass particle-deposited body and the deposition efficiency of the glass particles (average yield) were nearly the same as those obtained in Example 1. What is more, observation after the production of the glass particle-deposited body revealed that the thickness of the layer of the glass particles adhering on the inner surface of the reaction container reduced to two-thirds of the thickness experienced in Example 1. This result shows that the glass particles that did not adhere onto the starting material were effectively discharged from the reaction container. If the glass particles adhering on the inner surface of the reaction container come off and adhere onto the glass particle-deposited body, the adhering portions become optically and physically imperfect points. Therefore, it is desirable to minimize the amount of the glass particles adhering onto the inner surface of the reaction container. According to this example, the introduction of clean air into the reaction container is effective in reducing the amount of the glass particles adhering onto the inner surface of the reaction container.

TABLE IV

| Uppermost-position pressure − | | |
|---|---|---|
| lowermost-position pressure | Diameter fluctuation | Average yield |
| (Pa) | (mm) | (%) |
| 1 | 14 | 63 |
| 2 | 4 | 70 |
| 5 | 4 | 74 |
| 10 | 3 | 73 |
| 15 | 3 | 73 |
| 20 | 3 | 73 |
| 25 | 2 | 71 |
| 30 | 2 | 67 |
| 35 | 2 | 49 |

The present invention is described above in connection with what is presently considered to be the most practical and preferred embodiments. However, the invention is not limited to the disclosed embodiments, but, on the contrary, is intended to cover various modifications and equivalent arrangements included within the spirit and scope of the appended claims.

The entire disclosure of Japanese patent application 2003-058957 filed on Mar. 3, 2003 including the specification, claims, drawing, and summary is incorporated herein by reference in its entirety.

What is claimed is:

1. A method of producing a glass particle-deposited body, the method using a reaction container provided with:
(a) at least one burner for synthesizing glass particles;
(b) at least one gas-discharging port; and
(c) a gas-discharging pipe connected to the or each gas-discharging port;
the method comprising the steps of:
(d) synthesizing glass particles by using the at least one burner in the container; and
(e) moving at least one member selected from the group consisting of (e1) the at least one burner and (e2) a starting material so that the glass particles can adhere onto the surface of the starting material to be deposited there;
the method being specified by the condition that:
(f) the reaction container's internal pressure P_{H} is defined as the pressure at the uppermost position in a space for the movement of at least one member selected from the group consisting of (f1) the at least one burner and (f2) the starting material's surface onto which the glass particles are to adhere;
(g) the reaction container's internal pressure P_{L} is defined as the pressure at the lowermost position in the space; and
(h) the pressure P_{H} is adjusted to be higher than the pressure P_{L} by 2 to 30 Pa.

2. A method of producing a glass particle-deposited body as defined by claim 1, wherein:
(a) the at least one gas-discharging port is at least two gas-discharging ports; and
(b) the pressure in the gas-discharging pipe is adjusted such that the pressure increases with increasing height of the position of the gas-discharging port to which the gas-discharging pipe is connected.

3. A method of producing a glass particle-deposited body as defined by claim 1, wherein the reaction container further provided with a heat source in it to achieve the pressure P_{H} higher than the pressure P_{L} by using the heat supplied from the heat source.

4. A method of producing a glass particle-deposited body, the method using a reaction container provided with:
(a) at least one burner for synthesizing glass particles;
(b) at least two gas-discharging ports; and
(c) a gas-discharging pipe connected to each of the at least two gas-discharging ports;
the method comprising the steps of:
(d) synthesizing glass particles by using the at least one burner in the container; and
(e) causing the glass particles to adhere onto the surface of a starting material to be deposited there;
the method being specified by the condition that the pressure in the gas-discharging pipe is adjusted such that the pressure increases with increasing height of the position of the gas-discharging port to which the gas-discharging pipe is connected.

5. A method of producing a glass particle-deposited body as defined by claim 1, wherein the at least one gas-discharging port is placed at the same height as that of the at least one burner for synthesizing glass particles.

6. A method of producing a glass particle-deposited body as defined by claim 4, wherein at least one of the at least two gas-discharging ports are placed at the same height as that of the at least one burner for synthesizing glass particles.

7. A method of producing a glass particle-deposited body, the method using a reaction container provided with:
(a) at least one burner for synthesizing glass particles;
(b) at least one gas-discharging port; and
(c) a gas-discharging pipe connected to the or each gas-discharging port;
the method comprising the steps of:
(d) synthesizing glass particles by using the at least one burner in the container; and
(e) vertically raising a starting material so that the glass particles can adhere onto the surface of the starting material to be deposited there;
the method being specified by the condition that:
(f) the highest and lowest positions are determined among the positions of the group consisting of:
(f1) the position of the top of the at least one burner;
(f2) the position at which the center axis of the at least one burner extended in the direction of the flame issuing from the at least one burner intersects the wall of the reaction container; and
(f3) the position at which the at least one gas-discharging port is placed; and
(g) the reaction container's internal pressure at the highest position is adjusted to be higher than the reaction container's internal pressure at the lowest position by 2 to 30 Pa.

8. A method of producing a glass particle-deposited body as defined by claim 1, wherein the reaction container further provided with at least one clean gas-feeding port;
the method further comprising the step of feeding a clean gas into the reaction container from the at least one clean gas-feeding port;
the method being further specified by the condition that the pressure of the clean gas fed from the at least one clean gas-feeding port is the same as or higher than the pressure in the reaction container at the same height as that of the at least one clean gas-feeding port.

9. A method of producing a glass particle-deposited body as defined by claim 4, wherein the reaction container further provided with at least one clean gas-feeding port;
the method further comprising the step of feeding a clean gas into the reaction container from the at least one clean gas-feeding port;
the method being further specified by the condition that the pressure of the clean gas fed from the at least one clean gas-feeding port is the same as or higher than the pressure in the reaction container at the same height as that of the at least one clean gas-feeding port.

10. A method of producing a glass particle-deposited body as defined by claim 6, wherein the reaction container further comprises at least one clean gas-feeding port;
the method further comprising the step of feeding a clean gas into the reaction container from the at least one clean gas-feeding port;
the method being further specified by the condition that the pressure of the clean gas fed from the at least one clean gas-feeding port is the same as or higher than the pressure in the reaction container at the same height as that of the at least one clean gas-feeding port.

11. A method of producing a glass particle-deposited body as defined by claim 1, wherein the at least one gas-discharging port is at least two gas-discharging ports;
the method being further specified by the condition that:
(a) the reaction container's internal pressure is measured at a position some distance apart in a direction horizontally from the center of each of the gas-discharging ports;
(b) the internal pressure of each of the gas-discharging pipes connected to the gas-discharging ports is measured at a position some distance apart horizontally from the center of the gas-discharging port to which it is connected;
(c) the difference between the two pressures expressed in (a) and (b) above with respect to each of the gas-discharging ports is obtained (the difference is referred to as the difference between the inside and outside pressures of the gas-discharging port); and
(d) the difference between the inside and outside pressures of each of the gas-discharging ports is adjusted to fall within the range of 70% to 130% of the average value of the differences between the inside and outside pressures of all of the gas-discharging ports.

12. A method of producing a glass particle-deposited body as defined by claim 6, wherein the at least one gas-discharging port is at least two gas-discharging ports;
the method being further specified by the condition that:
(a) the reaction container's internal pressure is measured at a position some distance apart in a direction horizontally from the center of each of the gas-discharging ports;
(b) the internal pressure of each of the gas-discharging pipes connected to the gas-discharging ports is measured at a position some distance apart horizontally from the center of the gas-discharging port to which it is connected;
(c) the difference between the two pressures expressed in (a) and (b) above with respect to each of the gas-discharging ports is obtained (the difference is referred to as the difference between the inside and outside pressures of the gas-discharging port); and
(d) the difference between the inside and outside pressures of each of the gas-discharging ports is adjusted to fall within the range of 70% to 130% of the average value of the differences between the inside and outside pressures of all of the gas-discharging ports.

13. A method of producing a glass particle-deposited body as defined by claim 4, the method being further specified by the condition that:
(a) the reaction container's internal pressure is measured at a position some distance apart in a direction horizontally from the center of each of the gas-discharging ports;
(b) the internal pressure of each of the gas-discharging pipes connected to the gas-discharging ports is measured at a position some distance apart horizontally from the center of the gas-discharging port to which it is connected;
(c) the difference between the two pressures expressed in (a) and (b) above with respect to each of the gas-discharging ports is obtained (the difference is referred to as the difference between the inside and outside pressures of the gas-discharging port); and
(d) the difference between the inside and outside pressures of each of the gas-discharging ports is adjusted to fall within the range of 70% to 130% of the average value of the differences between the inside and outside pressures of all of the gas-discharging ports.
